(19) United States
(12) Patent Application Publication
(10) Pub. No.: US 2026/0147381 A1
(43) Pub. Date: May 28, 2026

(54) PALM COMFORT PAD FOR LAPTOP

(71) Applicant: Holly Harvey-Smith, Maple Valley, WA (US)

(72) Inventor: Holly Harvey-Smith, Maple Valley, WA (US)

(21) Appl. No.: 19/393,189

(22) Filed: Nov. 18, 2025

Related U.S. Application Data
(60) Provisional application No. 63/724,631, filed on Nov. 25, 2024.
(60) Provisional application No. 63/846,757, filed on Jul. 18, 2025.

(51) Int. Cl. G06F 1/16; A47B 21/03; G06F 3/039

(52) U.S. Cl. CPC G06F 1/1656; A47B 21/0371; G06F 1/1616; G06F 3/0393; A47B 2021/0385

(57) ABSTRACT

A palm support pad for use with a laptop is disclosed and may include a c-shaped body configured to wrap around a front edge of the laptop and to be spaced apart from a keyboard and a touchpad of the laptop. The c-shaped body may be removably coupled to the laptop when wrapped around the front edge of the laptop.

### BACKGROUND

### Technical Field

The present disclosure relates to a laptop accessory, specifically a laptop accessory for providing increased comfort for a user's hands.

### Description of the Related Art

When using the touchpad on several popular laptop models, the palms of the user may rub against a blunt front edge of the laptop. After a short period of time, the palms may become irritated, which may cause pain to the user. Current solutions for the uncomfortable hand position do not appear to address the potential pain in the palms of the user caused by the front edge of the laptop. Additionally, a number of options presently available that tout palm protection are designed to prevent damage to the laptop, but do not address pain to the user. The present options for pain are primarily catering to wrist pain, and are large and bulky, making transport of a laptop, and usage on an unstable surface, challenging.

### BRIEF SUMMARY

Embodiments described herein include palm comfort pads to be coupled to a laptop to reduce hand discomfort of a user of the laptop. For example, the disclosed palm comfort pads may provide a device for a user to rest their hands upon.

In one embodiment, palm support pad for use with a laptop includes a c-shaped body configured to wrap around a front edge of the laptop and sized and shaped to be spaced apart from a keyboard and a touchpad of the laptop. The c-shaped body may be removably coupled to the laptop when wrapped around the front edge of the laptop.

In some embodiments, the c-shaped body may be configured such that a top arm and a bottom arm of the c-shaped body are resilient such that the top arm and the bottom arm are biased toward a center space defined therebetween when separated. The top arm and the bottom arm may pinch toward the center space when spaced apart to receive the laptop. The c-shaped body may be removably coupled to the laptop without assistance from a fastener.

In some embodiments, a top arm of the c-shaped body may define an indentation. The indentation may be configured such that the palm support pad is adjacent to the touchpad of the laptop on three sides of the touchpad without covering or impeding access to the touchpad.

In some embodiments, The c-shaped body may extend in a c-shape along an entirety of a longitudinal length of the palm support pad. A top surface of the c-shaped body may slope toward a top surface of a topcase of the laptop in a direction toward a screen of the laptop from the front edge of the laptop. A distal end of a bottom arm of the c-shaped body may be configured to terminate adjacent to a bottom side of the laptop when the c-shaped body is removably coupled to the laptop.

In some embodiments, the palm support pad may further comprise a venting structure configured to enable air flow to pass therethrough to a vent of the laptop.

Among other benefits, aspects of the embodiments disclosed herein may provide additional comfort in a compact size, removable coupling to the laptop, and use across a number of laptop configurations.

### BRIEF DESCRIPTION OF THE SEVERAL VIEWS OF THE DRAWINGS

FIG. 1 shows a perspective view of a laptop with a palm comfort pad according to a first embodiment coupled thereto.

FIG. 2 shows a top view of the laptop of FIG. 1.

FIG. 3 shows a side view of the laptop of FIG. 1.

FIG. 4 shows a bottom view of the laptop of FIG. 1.

FIG. 5 shows a side view of the palm comfort pad shown in FIG. 1.

FIG. 6 shows a top view of the palm comfort pad of FIG. 1.

FIG. 7 shows a front view of the palm comfort pad of FIG. 1.

FIG. 8 shows a bottom view of the palm comfort pad of FIG. 1.

FIG. 9 shows a top, front, right perspective view of the palm comfort pad of FIG. 1.

FIG. 10 shows a top, rear, right perspective view of the palm comfort pad of FIG. 1.

FIG. 11 shows a bottom, front, right perspective view of the palm comfort pad of FIG. 1.

FIG. 12 shows a bottom, rear, right perspective view of the palm comfort pad of FIG. 1.

FIG. 13 shows a side view of a palm comfort pad according to a second embodiment.

FIG. 14 shows a side view of a laptop with the palm comfort pad of FIG. 6 coupled thereto.

FIG. 15 shows a top view of a laptop with a palm comfort pad according to a third embodiment coupled thereto.

FIG. 16 shows a top view of the palm comfort pad of FIG. 15.

FIG. 17 shows a front view of the palm comfort pad of FIG. 15.

FIG. 18 shows a bottom view of the palm comfort pad of FIG. 15.

FIG. 19 shows a side view of the palm comfort pad of FIG. 15.

FIG. 20 shows a top, front, right perspective view of the palm comfort pad of FIG. 15.

FIG. 21 shows a top, rear, right perspective view of the palm comfort pad of FIG. 15.

FIG. 22 shows a bottom, front, right perspective view of the palm comfort pad of FIG. 15.

FIG. 23 shows a bottom, rear, right perspective view of the palm comfort pad of FIG. 15.

FIG. 24 shows a partial front view of a laptop with a palm comfort pad according to a fourth embodiment coupled thereto.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and techniques associated with laptop accessories may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

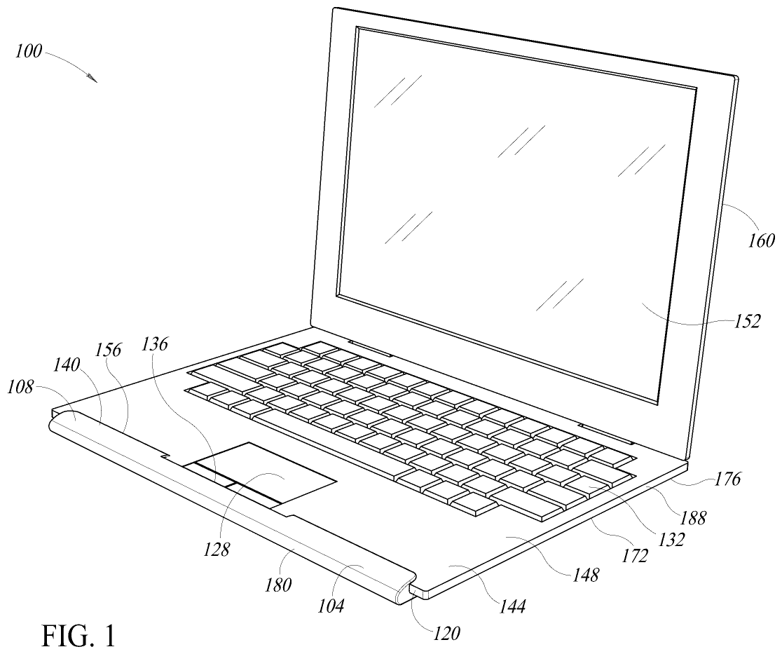

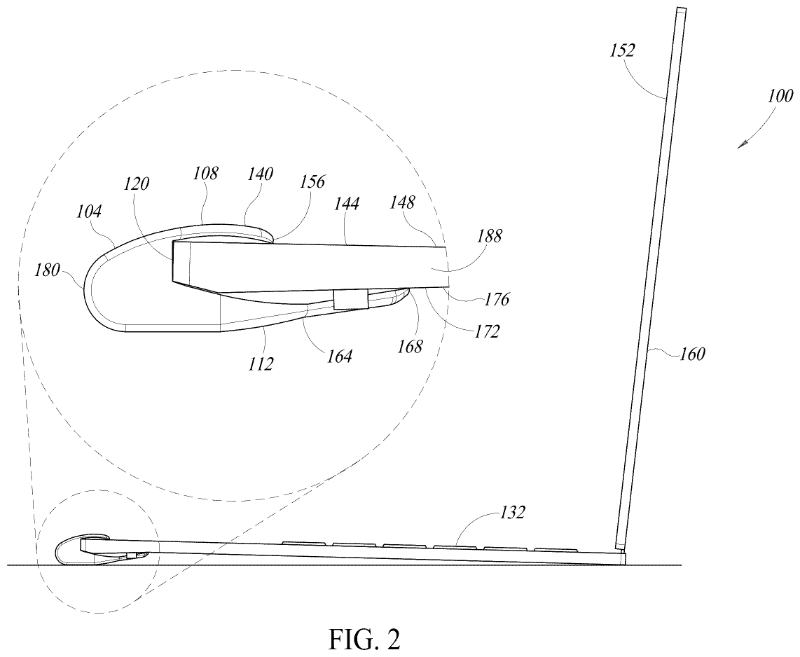

FIG. 1 shows a laptop 100 with a first embodiment of a palm comfort pad 104 coupled thereto. The palm comfort pad 104 may be generally C-shaped, or of a similar shape, as most clearly shown in FIG. 2. The palm comfort pad 104 may include a top arm 108 and a bottom arm 112. The top arm 108 and the bottom arm 112 may at least partially define a space 116 therebetween. The top arm 108 and the bottom arm 112 may be biased toward the space 116 therebetween when the top arm 108 and the bottom arm 112 are spaced apart from each other. The palm comfort pad 104 is configured to grip a front edge 120 of the laptop 100 when the front edge 120 of the laptop 100 is received in the space 116 between the top arm 108 and the bottom arm 112. When gripping the front edge 120 of the laptop 100, the palm comfort pad 104 may be removably coupled thereto.

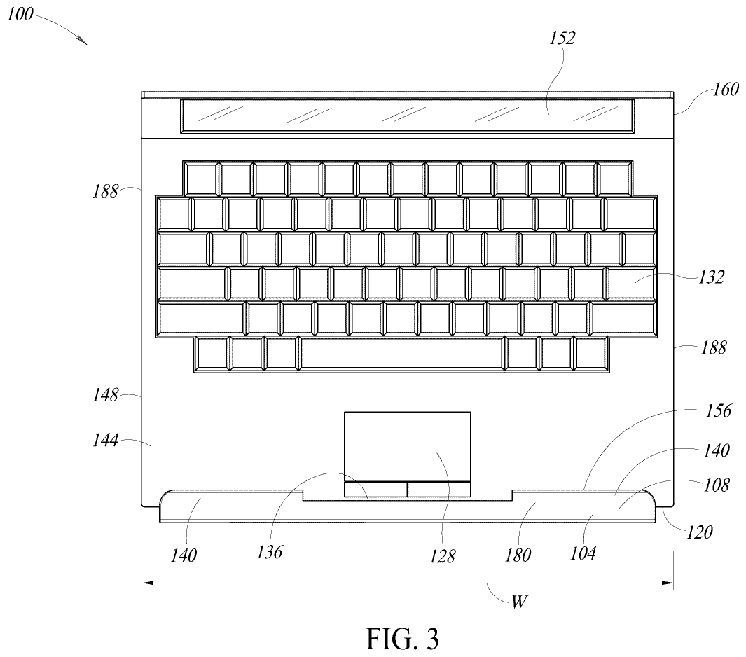

The palm comfort pad 104 may comprise plastic, silicone, or any other suitable material. The palm comfort pad 104 may generally be smooth to the touch. The palm comfort pad 104 comprises a single body, but in some embodiments, the palm comfort pad 104 may include a multiple component construction. The palm comfort pad 104 may be configured to wrap around a front edge 120 of the laptop 100 without impeding a user's access to a touchpad 128 and a keyboard 132 of the laptop 100. In such embodiments, the palm comfort pad 104 may be sized and shaped to be spaced apart from the touchpad 128 and the keyboard 132 of the laptop 100. For example, as shown in FIG. 3, the top arm 108 of the palm comfort pad 104 defines a cutout 136 (i.e., an indentation) which may accommodate at least a portion of the touchpad 128 when the palm comfort pad 104 is coupled to the laptop 100. The palm comfort pad 104 may be configured to avoid covering any portion of the touchpad 128 and/or the keyboard 132 of the laptop 100. The cutout 136 may be rectangular-shaped, trapezoidal-shaped, or any other desirable shape.

In some embodiments, a top surface 140 of the palm comfort pad 104 may gently slope toward a top surface 144 of a topcase 148 of the laptop 100 in a direction of a screen 152 of the laptop 100, as shown in FIG. 2. Such sloping of the top surface 140 of the palm comfort palm 104 enables a feeling of a smooth transition from the palm comfort pad 104 to the topcase 148 of the laptop 100 for the user. In other words, when nearing a distal end 156 of the top arm 108 of the palm comfort pad 104, the palm comfort pad 104 may be nearly flush with the top surface 144 of the topcase 148 of the laptop 100. The top arm 108 of the palm comfort pad 104 may be sized and shaped such that the laptop 100 may be closed when the palm comfort pad 104 is coupled thereto. In this regard, the laptop is “closed” when the laptop 100 senses the lid 160 of the laptop 100 as being closed. A bottom surface 164 of the palm comfort pad 104 may be configured such that the laptop 100 may be used on any desirable surface, including a desk and a lap of the user. In some embodiments, the bottom surface 164 of the palm comfort pad 104 may be generally flat, such as in the embodiment shown in FIG. 2. In some embodiments, the bottom arm 112 of the palm comfort pad 104 may be gently sloped such that a distal end 168 of the bottom arm 112 of the palm comfort pad 104 may be nearly flush with a bottom surface 172 of a bottomcase 176 of the laptop 100. A front surface 180 of the palm comfort pad 104 may be curved.

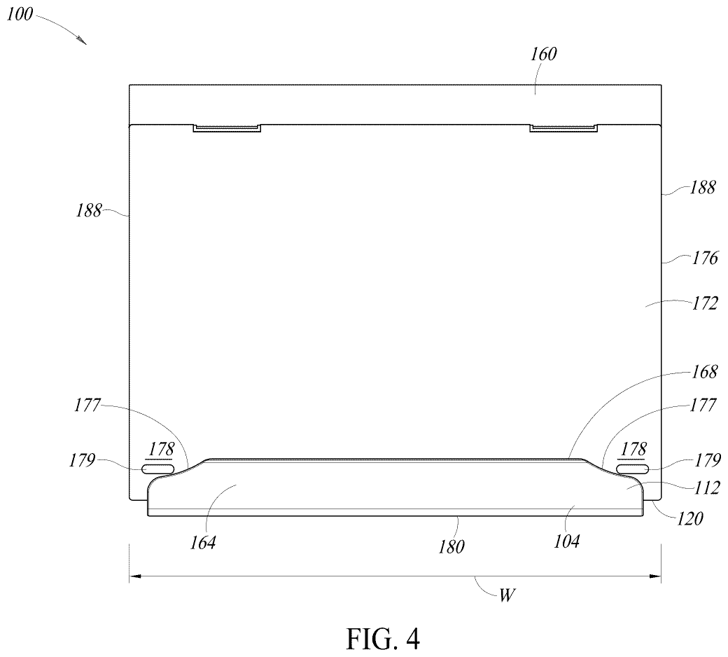

A bottom view of the palm comfort pad 104 when coupled to the laptop is shown in FIG. 4. The bottom arm 112 of the palm comfort pad 104 may include at least one angled cutout 177, which each define a space 178 for a foot 179 of the laptop 100. In some embodiments, such as the embodiment shown in FIG. 4, the angled cutouts 177 are present on the distal end 168 of the bottom arm 112 of the palm comfort pad 104.

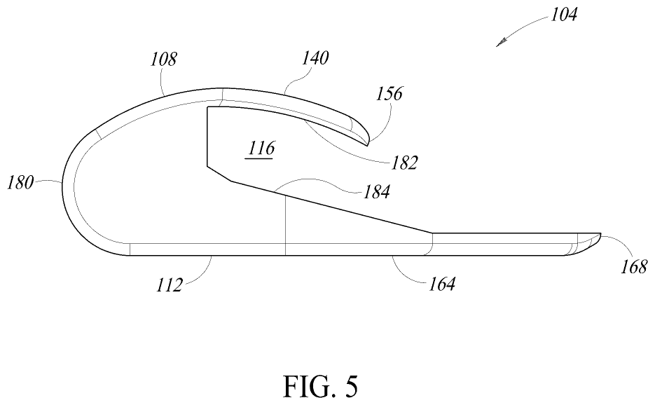

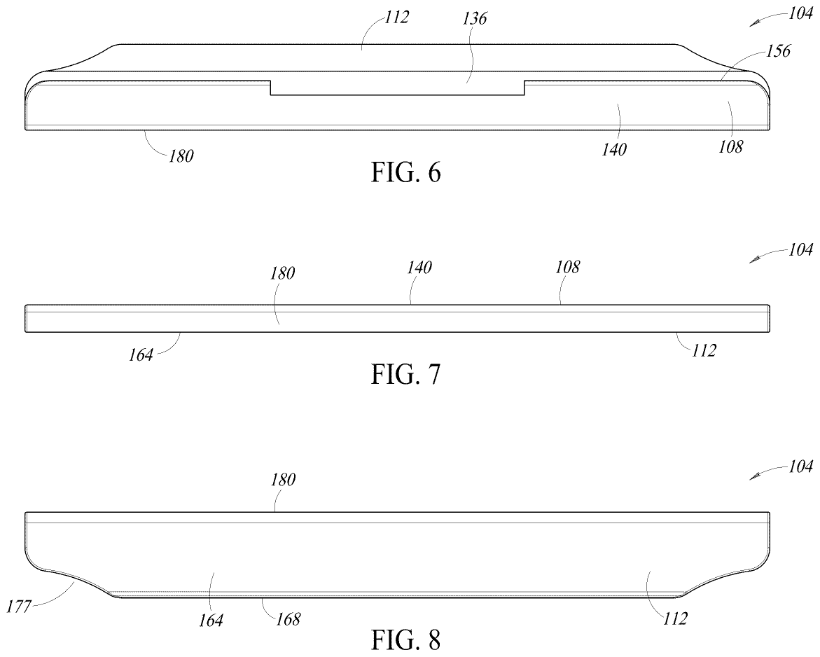

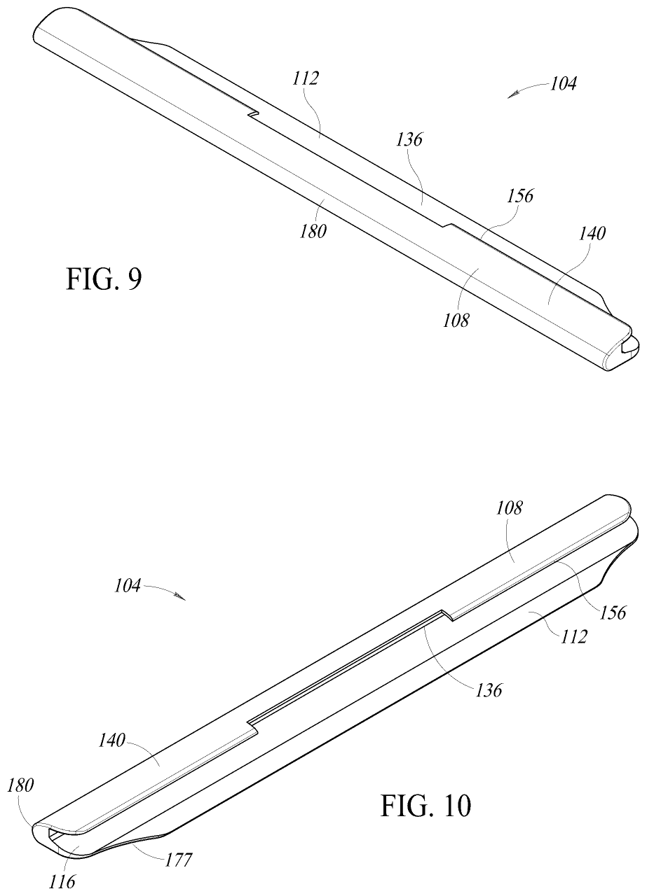

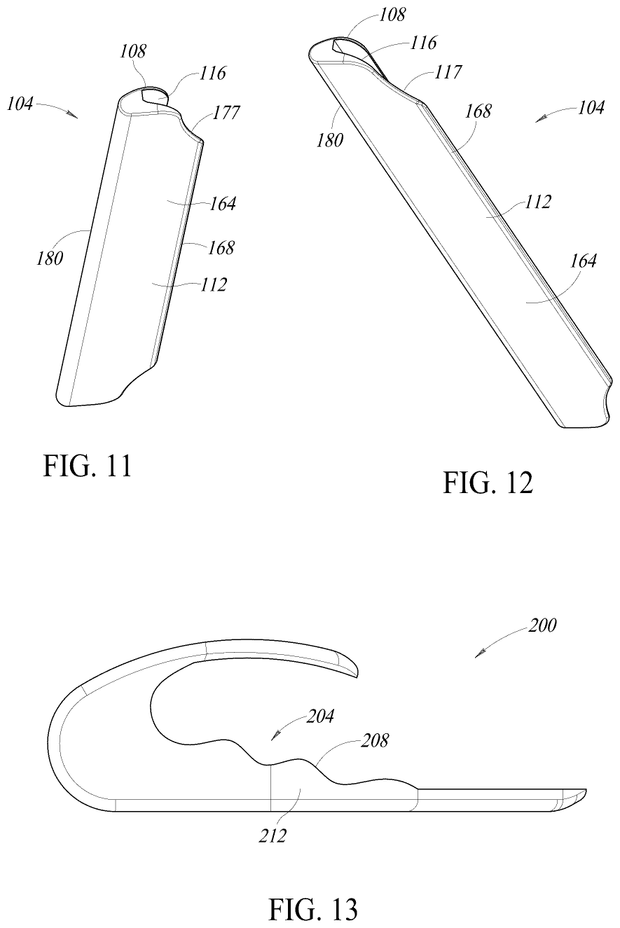

FIGS. 5-12 show the palm comfort pad 104 when not coupled to the laptop 100. FIG. 5 shows a side view of the palm comfort pad 104 when not coupled to the laptop 100. As shown in FIG. 5, the palm comfort pad 104 may be configured such that the top arm 108 and the bottom arm 112 thereof are biased toward the center space 116 therebetween. Put another way, the top arm 108 and the bottom arm 112 of the palm comfort pad 104 may be configured to pinch inward. The bias of the top arm 108 and the bottom arm 112 may enable the palm comfort pad 104 to be removably coupled to the laptop 100 by gripping the topcase 148 and the bottomcase 176 of the laptop 100. In such a configuration, the palm comfort pad 104 may be slid onto the front edge 120 of the laptop 100 for installation. In some embodiments, neither an adhesive nor a fastener is necessary to couple the palm comfort pad 104 to the laptop 100. However, in some embodiments, an adhesive may be present on a contact surface 182 of the top arm 108 of the palm comfort pad 104 and/or on a contact surface 184 of the bottom arm 112 of the palm comfort pad 104. In such embodiments, the adhesive may assist in coupling the palm comfort pad 104 to laptop 100. In some embodiments, the adhesive may be configured such that the palm comfort pad 104 and the laptop 100 may be decoupled and recoupled at a subsequent time. In other words, the adhesive may be reusable.

Additionally, because the bias of the palm comfort pad 104 enables gripping of the front edge 120 of the laptop 100, the bottom arm 112 of the palm comfort pad 104 only needs to be long enough to couple the palm comfort pad 104 to the laptop 100. In other words, the bottom arm 112 of the palm comfort pad 104 need not extend to a back side of the laptop 100 to remain coupled, thereby reducing the required size of the palm comfort pad 104.

The palm comfort pad 104 may not include side portions adjoining the center space 116, such that the center space 116 is devoid of material along an entirety of the palm comfort pad 104. In other words, the generally C-shape of the palm comfort pad 104 may extend along an entirety of the palm comfort pad 104, or a majority of the palm comfort pad 104. In such configurations, the palm comfort pad 104 does not cover a side edge 188 of the laptop 100. Such a configuration enables the palm comfort pad 104 to be used on a variety of sizes of laptops without limiting a maximum width W of the laptop 100 to be coupled to the palm comfort pad 104.

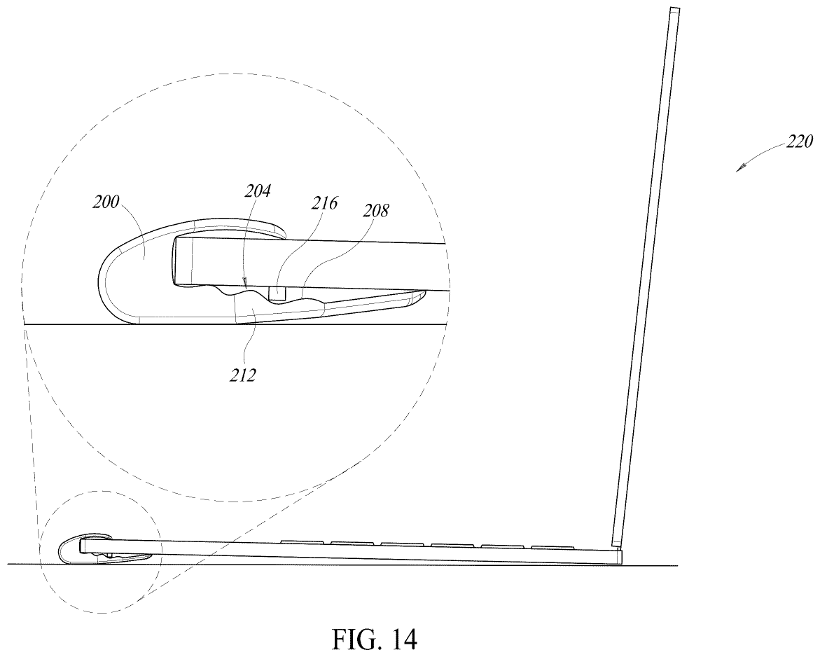

A side view of an alternative embodiment of a palm comfort pad 200 is shown in FIG. 13. The palm comfort pad 200 shown in FIG. 13 is similar to the palm comfort pad 104 of FIGS. 1-12, however, the palm comfort pad 200 of FIG. 13 includes ridges 204 on an upper surface 208 of a bottom arm 212 thereof. The ridges 204 may assist in creating stronger coupling between the palm comfort pad 200 and a laptop by increasing friction therebetween. In some embodiments, such as in the example embodiment shown in FIG. 14, the ridges 204 may be configured to receive feet 216 of a laptop 220 therein. In some embodiments, the ridges 204 may be configured to accommodate any of a plurality of laptop feet designs, such that a single palm comfort pad 200 may be used on a number of laptop configurations.

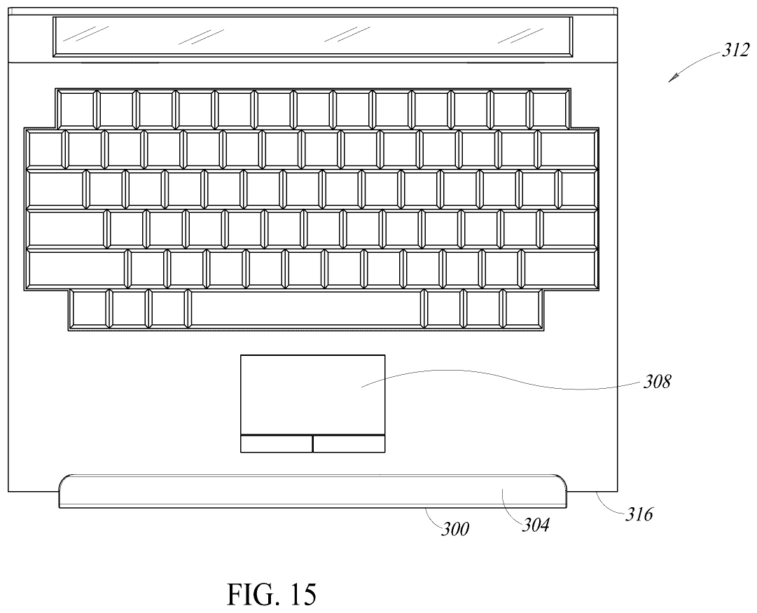

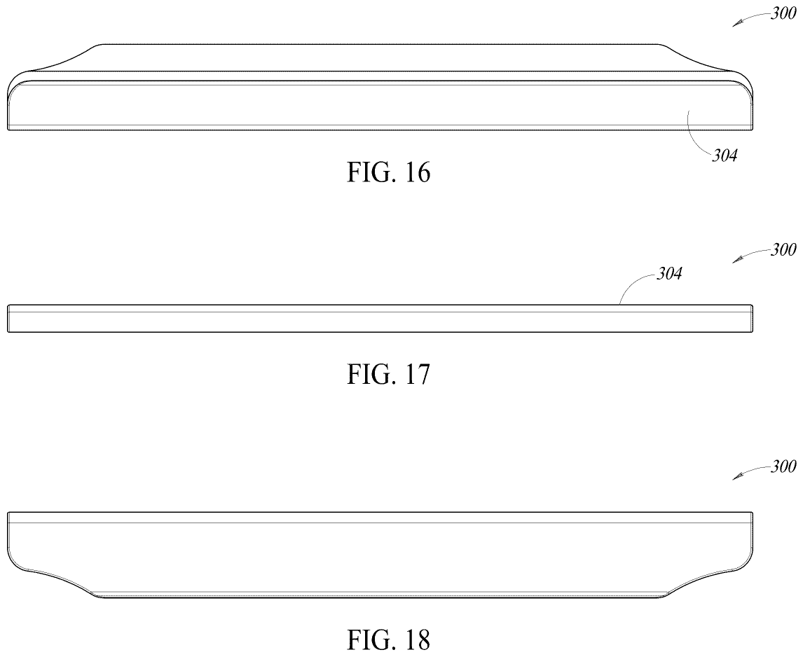

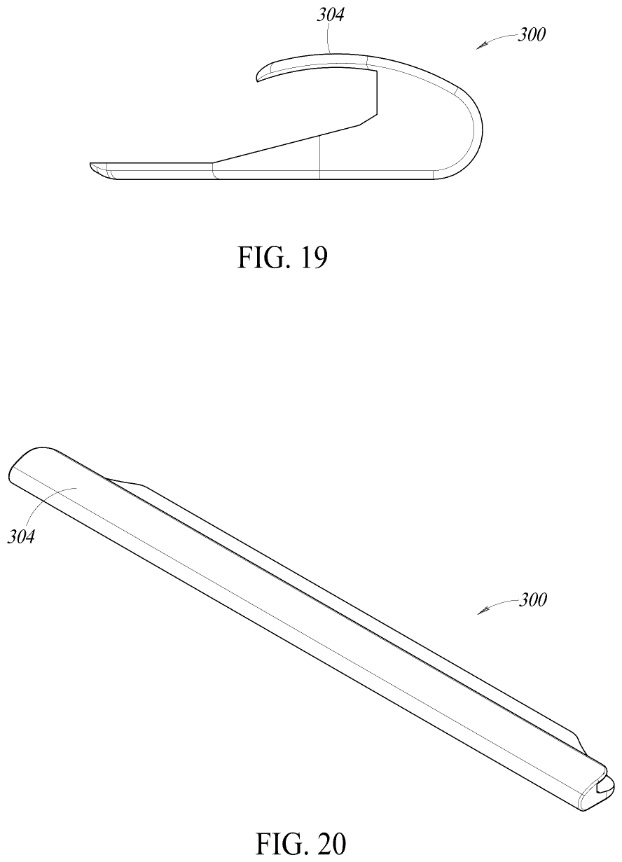

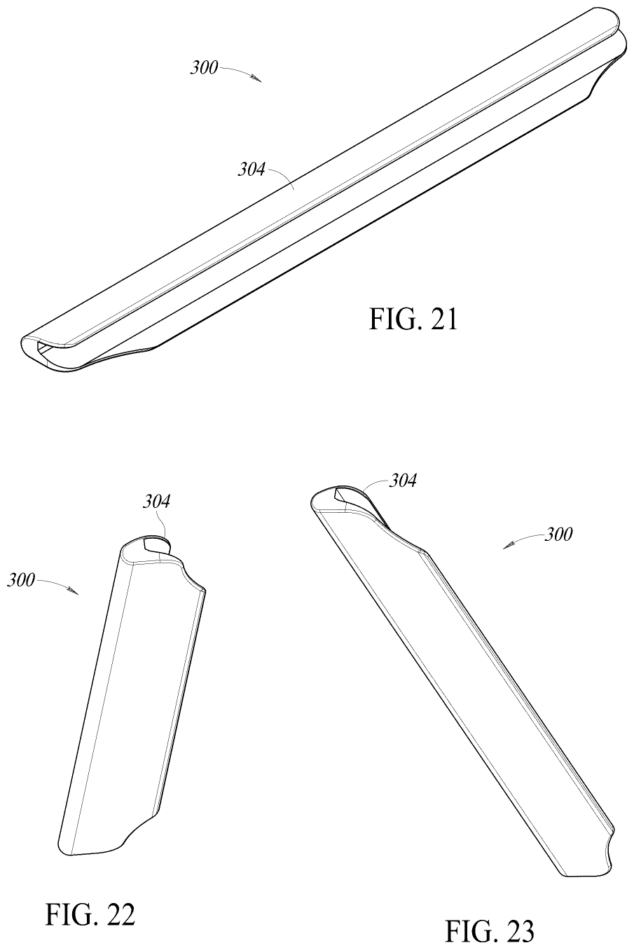

A top view of another alternative embodiment of a palm comfort pad 300 is shown in FIGS. 15-23. The palm comfort pad 300 shown in FIGS. 15-23 is similar to the palm comfort pad 104 of FIGS. 1-12, however, a top arm 304 the palm comfort pad 300 of FIGS. 15-23 does not define a cut out in which a touchpad 308 of a laptop 312 may be positioned. In the embodiment shown in FIG. 15, the touchpad 308 of the laptop 312 is spaced apart from a front edge 316 of the laptop 312 providing ample space for the top arm 304 of the palm comfort pad 300 without interfering with use of the touchpad 308. Such a configuration enables a single palm comfort pad 300 to provide comfort to both of the user's hands even when the user's hands are positioned to a side of the touchpad 308, while still enabling full use of the touchpad 308 of the laptop 312.

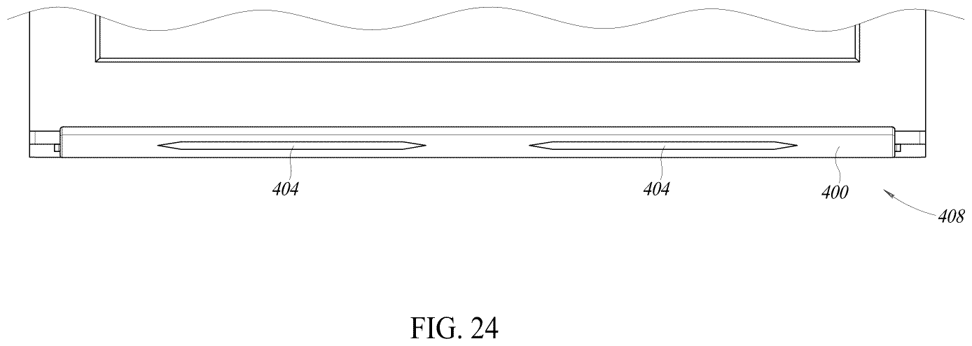

A front view of yet another alternative embodiment of a palm comfort pad 400 is shown in FIG. 24. As shown in the embodiment of FIG. 24, the palm comfort pad 400 may include at least one venting structure 404 which is configured to enable air to flow therethrough to cooling vents of a laptop 408 to which the palm comfort pad 400 is coupled. The venting structure 404 may be complete openings, a series of openings, a mesh, or any other configuration which enables flow of air therethrough. It should be understood that the venting structure 404 may be positioned at any location on the palm comfort pad 400 which enables air flow to the cooling vents of the laptop 408. The venting structure 404 may also be utilized in association with a speaker of the laptop 408. For example, the venting structure 404 may be positioned to enable sound from a speaker of the laptop 408 to travel therethrough.

The palm comfort pads disclosed herein provide a number of benefits over present laptop accessories. Notably, the palm comfort pads are coupleable to a laptop without requiring extensive space surrounding the laptop. Additionally, the palm comfort pads disclosed herein must only be large enough to sufficiently grip the front edge of the laptop, which may reduce the size of the palm comfort pad and increase the portability thereof. The palm comfort pads of the embodiments described above enable normal keyboard and touchpad operation for a user thereof when coupled to the user's laptop. Whether a palm comfort pad includes the various features described above, such as a cutout defining a space for touchpad and a venting structure, may be dependent on the configuration of the laptop to which the individual palm comfort pad is designed to be couped to. In other words, the palm comfort pad disclosed herein may be configured in accordance with the design of a specific laptop.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A palm support pad for use with a laptop comprising:
a c-shaped body configured to wrap around a front edge of the laptop and sized and shaped to be spaced apart from a keyboard and a touchpad of the laptop,
wherein the c-shaped body is removably coupled to the laptop when wrapped around the front edge of the laptop.

2. The palm support pad of claim 1, wherein a top arm of the c-shaped body defines an indentation, the indentation configured such that the palm support pad is adjacent to the touchpad of the laptop on three sides of the touchpad without covering the touchpad.

3. The palm support pad of claim 1, wherein a top surface of the c-shaped body slopes toward a top surface of a topcase of the laptop in a direction toward a screen of the laptop from the front edge of the laptop.

4. The palm support pad of claim 1, wherein the c-shaped body is configured such that a top arm and a bottom arm of the c-shaped body are resilient such that the top arm and the bottom arm are biased toward a center space defined therebetween when separated, such that the top arm and the bottom arm pinch toward the center space when spaced apart to receive the laptop.

5. The palm support pad of claim 1, wherein the c-shaped body is removably coupled to the laptop without assistance from a fastener.

6. The palm support pad of claim 1, wherein a distal end of a bottom arm of the c-shaped body is configured to terminate adjacent to a bottom side of the laptop when the c-shaped body is removably coupled to the laptop.

7. The palm support pad of claim 1, wherein the c-shaped body extends in a c-shape along an entirety of a longitudinal length of the palm support pad.

8. The palm support pad of claim 1, further comprising a venting structure configured to enable air flow to pass therethrough to a vent of the laptop.

9. The palm support pad of claim 1, wherein a bottom surface of the c-shaped body is flat.

10. The palm support pad of claim 1, wherein a top surface of the c-shaped body is curved.

11. The palm support pad of claim 1, wherein a front surface of a center portion of the c-shaped body is curved.

12. A palm support pad for use with a laptop comprising:
a c-shaped body having a top arm and a bottom arm, the top arm and the bottom arm partially defining a space therebetween, wherein the top arm and the bottom arm are both configured to be biased toward a space between the top arm and the bottom arm when the top arm and the bottom arm are separated from each other,
wherein the c-shaped body is configured to grip a front edge of a laptop when the front edge of the laptop is received in the space between the top arm and the bottom arm of the c-shaped body.

13. The palm support pad of claim 12, wherein the top arm of the c-shaped body defines an indentation, the indentation configured such that the palm support pad is adjacent to a touchpad of the laptop on three sides of the touchpad without covering the touchpad.

14. The palm support pad of claim 12, wherein a top surface of the top arm slopes toward a top surface of a topcase of the laptop in a direction toward a screen of the laptop from the front edge of the laptop.

15. The palm support pad of claim 12, wherein the c-shaped body is removably coupled to the laptop without assistance from a fastener.

16. The palm support pad of claim 12, wherein a distal end of the bottom arm of the c-shaped body is configured to terminate adjacent to a bottom side of the laptop when the c-shaped body is removably coupled to the laptop.

17. The palm support pad of claim 12, wherein the c-shaped body extends in a c-shape along an entirety of a longitudinal length of the palm support pad.

18. The palm support pad of claim 12, further comprising a venting structure configured to enable air flow to pass therethrough to a vent of the laptop.

19. The palm support pad of claim 12, wherein a bottom surface of the bottom arm is flat.

20. The palm support pad of claim 12, wherein a top surface of the top arm is curved.
